(19) United States
(12) Patent Application Publication
(10) Pub. No.: US 2006/0266102 A1
(43) Pub. Date: Nov. 30, 2006

(54) System, apparatus and method for detecting unknown chemical compounds

(76) Inventor: Charlie L. Tolliver, Katy, TX (US)

Correspondence Address: HARISH DHINGRA, 10700 Rockley Road, Houston, TX, 77099, US

(21) Appl. No.: 11/136,972

(22) Filed: May 25, 2005

(51) Int. Cl. G01N 7/00

(52) U.S. Cl. 73/23.2

(57) ABSTRACT

Apparatus and techniques for detecting unknown chemical compounds in the field are provided. A Digital Signal Processor (DSP) includes a database of chemical signatures and corresponding chemicals. An air sample is analyzed in the field and chemical signature of any chemicals present is determined. This chemical signature is then correlated with the chemicals in the database. If a match is found, the operator is alerted to the fact. If no match is found, the operator is alerted to the fact that an unknown chemical compound is found but no correlation could be found. A corresponding system and method are provided.

### CLAIM TO EARLIER PRIORITY DATE

None.

### CROSS-REFERENCE TO RELATED APPLICATIONS

None.

### STATEMENTS REGARDING FEDERALLY SPONSORED RESEARCH OR DEVELOPMENT

Inventor is an employee of a state university. Inventor believes that no federal funding is involved. Inventor, however, is in the process of clarifying the matter with his employer.

### REFERENCE TO A MICROFICHE APPENDIX

Not Applicable.

### BACKGROUND OF THE INVENTION

1. Field of the Invention

The present invention generally relates to security screening and surveillance, and more specifically to detecting contraband chemicals, typically narcotics and explosives, concealed from law enforcement authorities.

2. Description of the Related Art

The automobile has evolved into an excellent means of transportation for people around the world. The evolution continues, however, as some vehicles transport illegal and dangerous narcotics, flammable chemicals, and various explosives that are unlawful in themselves but in addition may lead to terrorist incidents and related violent activities. The law enforcement authorities are particularly mindful of economic and civic impact of such chemical transportation. The ultimate goal remains to eliminate all terrorist acts and the flow of narcotics and explosives in to the society.

The law enforcement authorities have an arsenal of means to address the issues raised above. One of the sophisticated techniques in detecting concealed contraband is use of trained canines to sniff those concealed chemical substances. This technique although generally reliable, suffers from many drawbacks and difficulties. First, only a few species of canines are capable of providing the sniffing service. Second, cost of training such canines is significant. Third, use of these canines requires that trained law enforcement personnel accompany them at all time to provide the sniffing service. Fourth, the sensitivity of the canine varies with prevailing environmental and physical conditions. Fifth, cost of maintaining a canine not only includes food and medicine but also cost of a trained human to accompany the canine. These running costs add up to significant amount of money and resources. Last but not the least, a canine may not be physically fit at the time of need because animals also get sick and thus may not be available when needed.

Therefore, to counter growing threats of dangerous chemical proliferation, it is desirable to develop techniques and means of detecting contraband chemicals which are reliable, available at all times, and are economical.

Thus, several techniques to overcome the difficulties mentioned above were investigated. Development of the systems appropriate for use in real-time that in efficient, less invasive, portable for use in place of a trained canine, and comprehensive in detection of such threats were considered.

### BRIEF SUMMARY OF THE INVENTION

A technique for detecting an unknown chemical compound in the field using an air sample is presented. In an exemplary embodiment, an air sample from the vicinity of the desired region is collected. This air sample is analyzed to determine chemical signature of the chemical compound if present. If a chemical signature of the unknown compound is detected, that chemical signature is matched with the chemical compounds in a database stored on a Digital Signal Processor and the operator is alerted. If no match is found, the operator is alerted to the fact that a new unknown chemical is present but no match could be found. The database is appropriately updated.

In another exemplary embodiment an apparatus for detecting an unknown chemical compound in the field using an air sample is illustrated. The apparatus uses a means for collecting an air sample from the vicinity of the unknown chemical compound; a chemical analyzer to analyze the unknown chemical compounds; and a Digital Signal Processor (DSP) coupled to the analyzer, the DSP comprising a database of chemical compounds and their chemical signature and further comprising means for associating the chemical signature with chemical compounds in the database.

In a still another embodiment a system corresponding to the technique illustrated is provided.

### BRIEF DESCRIPTION OF THE SEVERAL VIEWS OF THE DRAWINGS

A better understanding of the present invention can be obtained when the following detailed description of some embodiments is considered in conjunction with the drawings of the above noted application and the following drawings in which:

FIG. 1 is an overview flowchart of an exemplary embodiment illustrating the method of detecting unknown chemical compounds.

FIG. 2 is schematic of an exemplary embodiment illustrating apparatus for detecting unknown chemical compounds.

FIG. 3 is a physical diagram of the exemplary embodiment of the apparatus of FIG. 2.

FIG. 4 is the DSP Flow Chart, showing the integration of the DSP in the apparatus of FIG. 2.

FIGS. 5A and 5B are side view and front view of the internal details of the retractable tube corresponding to probe of the exemplary embodiment of FIG. 3.

FIG. 6 is the detailed view of IMS system of the exemplary embodiment of FIG. 2.

FIG. 7 is the working principle illustration of an IMS adapted in the exemplary embodiment of FIG. 2.

### DETAILED DESCRIPTION OF THE INVENTION

The observation that times for heightened security environment have arrived and that transportation of explosive chemicals and unlawful drugs may be on the rise requires significantly increased resources for screening of suspects consistent with the law. In this respect, canines are very adapt at detecting such chemicals. Availability of canines, however, is restricted to a few species. Requirements of training the canines and necessity of trained personnel accompanying the canines makes expanding the canine resource expensive and impractical. Another cost associated with the canines is that of feeding. Furthermore, the canines after feeding like to sleep and become effectively unavailable. Also, legal protections afforded individuals by using apparatus that substantially performs tasks of canines in non-intimidating fashion, would be acceptable to enforcement agencies. Therefore, to meet the challenges of expanding detection resources in an economically feasible manner, it is necessary to develop sensor and systems that are accurate, economical, and portable to be available in the field. Other usages of such sensors may be in manual or automated scanning of luggage at the airports, shipping terminals, shipping storage houses, post office facilities, and similar installations where such surveillance may be needed.

The following is a detailed description of example embodiments of the invention depicted in the accompanying drawings. The embodiments are examples and are in such detail as to clearly communicate the invention. However, the amount of detail offered is not intended to limit the anticipated variations of embodiments; on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

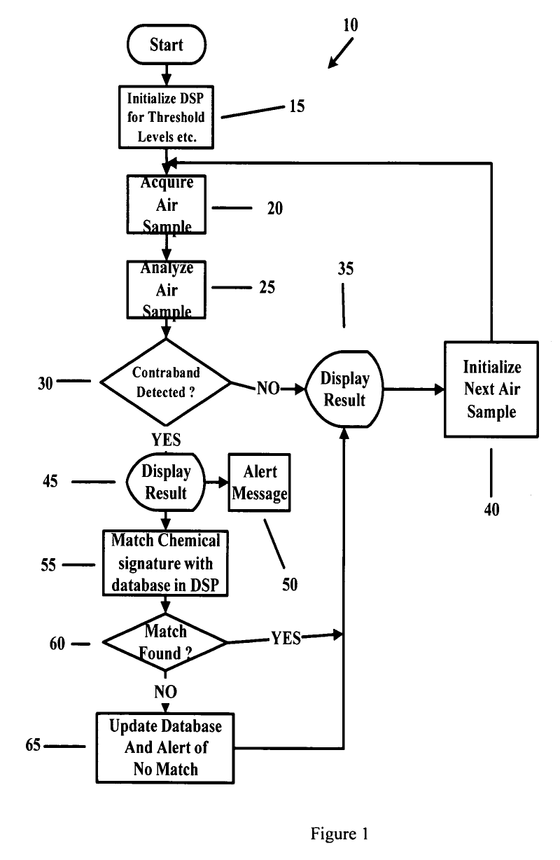

Referring to FIG. 1, there is illustrated a flowchart of the technique 10 for detecting unknown chemical compounds. First, the system is initialized 15 to set the threshold, detection sensitivity, and any other necessary parameter to start using the technique. The system is activated to acquire air sample 20, preferably in the proximity of the concealed chemical compound. Generally, location(s) of the concealed chemical is not known but after establishing the preliminary suspicion, the law enforcement person may acquire air samples from various locations in the vicinity of the suspected location using training skills and own experience. The air sample is then analyzed in step 25 for contraband material like narcotics/drugs and explosive chemicals to acquire chemical signature of the unknown chemical compound. In step 30, if such contraband matter is not detected, the results are displayed 35 appropriately on a display device, or communicated by an audio signal, or via wireless techniques well known to those skilled in the art. Likewise in step 30, if the contraband is detected, the results are displayed in step 45 on a display screen, or communicated by audio signal, or are communicated by wireless techniques. In step 40, next air sample from a different location, as necessary, is collected and the process from step 20 is repeated. If in step 30, a contraband chemical is detected, then such results are displayed for the operator and in step 45, a message 50 alerting to the fact that contraband has been detected is displayed. Further, in step 55 the chemical substance is matched with those stored in the database in a Digital Signal Processor (DSP). If a match in the database is found, the results are displayed and/or communicated to the responsible personnel or the computer for further action as necessary. If in step 60, no match of the chemical signature is found in the database, the database is updated with the chemical signature and an alert is communicated to investigate match for the new chemical signature and the results are displayed as described above.

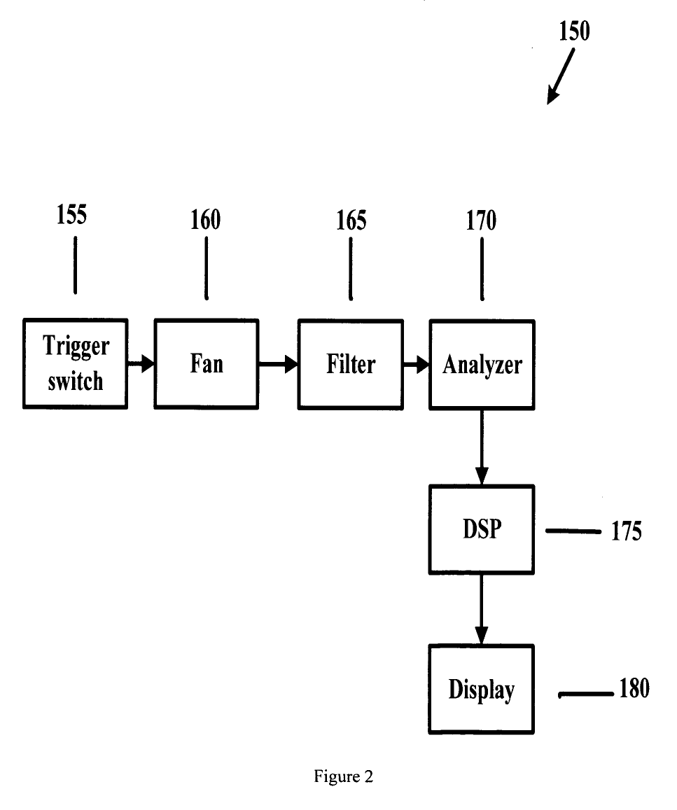

With reference to FIG. 2 is schematic of an exemplary embodiment illustrating apparatus 150 for detecting unknown chemical compounds. A trigger switch 155 is used to power on/off the apparatus and trigger the apparatus. A fan 160 is used to suck the sample air into the apparatus. A filter 165 is used to appropriately filter out dirt and other contaminants from the air sample. The filtered air sample is then analyzed in an analyzer 170. The chemical analyzer may be an Ion Mobility Spectroscope, a Filter-based Infrared Spectroscope, a Photo-Acoustic Infrared Spectroscope, or a Photo-Ionization Spectroscope, or suitable combinations thereof. In the example embodiment, the chemical analyzer most suited was determined to be Ion Mobility Spectroscope. In different circumstances other mentioned techniques may be found to be better suited as persons skilled in the art may well adapt the developing technologies at a later time. A DSP 175 further comprising necessary software and a database is coupled to the analyzer for associating the chemical signature with the chemicals stored in the database. A display 180 is used for displaying results of the analysis. The apparatus may have other means of communications like audio alarm, or wireless communication means for remote communication. The apparatus may have further means for location providing means like Global Positioning System receivers or radio transmitter/receiver to communicate with remote locations.

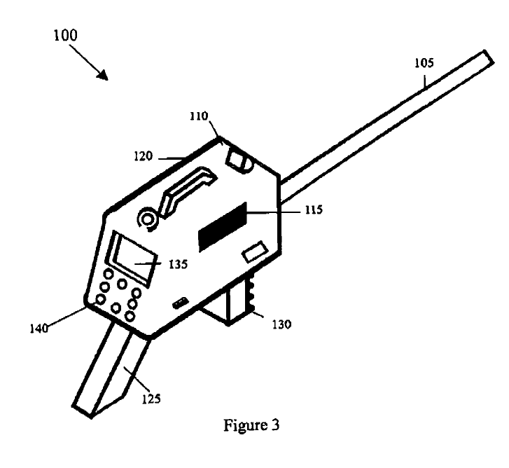

With reference to FIG. 3 there is illustrated a physical diagram 100 of an exemplary embodiment of the apparatus of FIG. 2. Air samples are drawn through a probe 105 of the apparatus. The probe in an exemplary embodiment is tubular shape of suitable diameter designed for good accessibility yet capable of sucking in air sample adequate for analysis. The function of the probe is to collect as good a sample as possible and capable of access to as wide a variety of spaces as is feasible. Therefore, the probe may be shaped in horn shape to enable it to improve volume of the air sample, or it may be provided with a fine tip to improve accessibility to narrow spaces. The probe may be designed to be retractable. Such modifications in probe design would be obvious to those skilled in the art.

Still referring to FIG. 3, the main body 110 is designed to house the necessary components and electronics for performing chemical analysis. The body can store a 12-V DC rechargeable battery. A 3.5×0.75 inch LCD touch screen control panel 135, a 0.15×3 inch side vent 115, and a trigger switch (not shown-hidden behind holding arm 125) analogous to a gun trigger or a switch, that may initiate the air suctioning, are provided. The holding clamps 120 are provided to allow a storage space for the suction probe once the trough has been retracted. In an exemplary embodiment, the probe is approximately 21.6 inches long from the tip of the trough to the back of the control panel and weighs about 6.75 pounds when empty. The control panel 135 is located on the back of the probe and comprises of eight buttons 140 to perform the following functions: power, save, recall, front seat, back seat, trunk, detection mode, and clear. The probe may be made capable of saving data based on the location at which the sample is taken, i.e., front seat, back seat, or trunk. The control may be a touch screen with the same buttons capability as stated above. A support 130 and a holding arm 125 are provided for convenience of the operator. In an exemplary embodiment, the body dimensions are 10.5×4.5×4.5 inches. The body is provided with an adjustable shoulder strap 120. The outside body material selected was Polyvinyl Chloride (PVC) for its ease of manufacture and chemical resistance. Further the structure was analyzed for structural integrity and thermal environment the apparatus was likely to encounter in the operation in the field and possibly affect sample collection. The trigger switch may be a toggle switch or a push button switch or any other switch convenient for safe operation. Liquid crystal display technology was preferably selected for control panel of the apparatus.

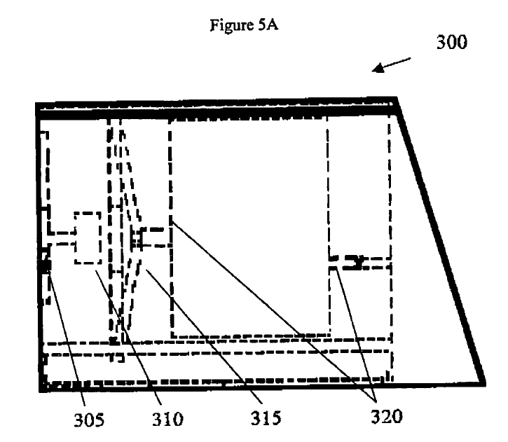

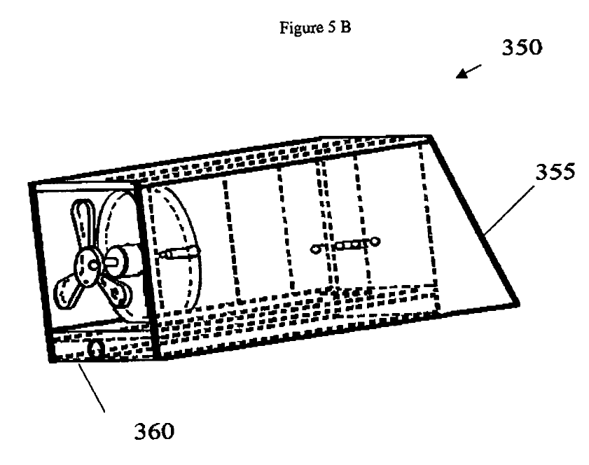

Referring to FIGS. 5A and 5B are side view 300 and front view 350 of the internal details of the retractable tube corresponding to the probe of the exemplary embodiment of FIG. 2 with suction fan attached thereto. A fan 305 attached to a motor 310 provides capability to suck an air sample. The air sample is filtered for dust like contaminants, or other elements that may degrade performance of the apparatus, through a filter 315. The filtered air is then analyzed by IMS (to be described in more detail). Controller chips 320 will also be described later. The fan is housed in an enclosure 355. The air suction hole 360 in an exemplary embodiment is located below the fan.

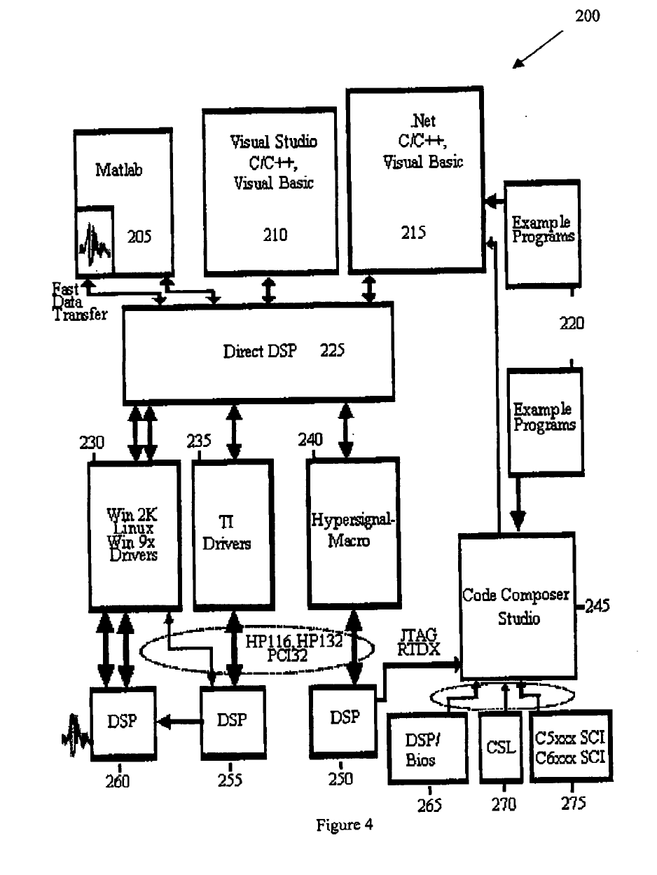

With reference to FIG. 4 is the DSP Flow Chart 200, showing the integration of the DSP in the apparatus of FIG. 2. An example open source program for operation of the DSP is listed below. The DSP is shipped with a DSP kit. This kit includes the DSP and an application driver. The application driver shipped with the DSP is the Code Composer Studio, which provides the gateway that communicates with the hardware and open source programs. These programs include MATLAB 205 and Visual Studio 210, and .NET 215. The open source program in one embodiment was preferably Visual Studio .NET. This program provides a reliable, robust and flexible environment that enables quick and easy update for the integration of the Ion Mobility System (IMS).

The code embedded on the DSP controls the readings for the sample collected and compares its findings to the control sample data related to the threshold level. If there is a difference between these two readings, the finding are communicated to Visual Studio .NET via the DSP application driver. This notifies the user of the apparatus that the sample collected does contain explosives and/or narcotics. The open source program, Visual Studio .NET provides an avenue for code maintenance without tedious compilation and distribution. It also facilitates for real time changes to the control sample data for different cities, counties and states via a secured environment accessible via the Internet. The data collected on any sample can be easily uploaded to a repository that can be tailored to track and provide law enforcement with information on the types of narcotics found on any given time frame.

I. An Example DSP Communication Program

Initialize the program

```
  Public Class FtpRequestCreator
    Implements IWebRequestCreate
    Public Sub New( )
    End Sub
    Public Overridable Function Create(ByVal Url As Uri)
As WebRequest Implements IWebRequestCreate.Create
      Return New FtpWebRequest(Url)
    End Function
  End Class
```

Used to create a Webrequest instance

```
    ‘ FtpRequestCreator class implements IWebRequestCreate
class, which implements Create method.
    Dim  Creator  As  FtpRequestCreator  =  New
FtpRequestCreator( )
    WebRequest.RegisterPrefix(“ftp:”, Creator)
    Dim szUri As String = New String(“ftp://localhost”)
  ‘ Create WebRequest.
  Dim w As WebRequest = WebRequest.Create(szUri)
```

Registers and notifies the descendants to use the FTP protocol for retrieving the data

```
Dim r As WebResponse = w.GetResponse( )
Dim respstream As Stream = r.GetResponseStream( )
If (respstream.CanRead) Then
    Dim  rdr  As  StreamReader  =  New
StreamReader(respstream)
    Dim resp As String = rdr.ReadToEnd( )
    rdr.Close( )
    Console.WriteLine(resp)
  End If
```

This block of code gets the public URL request.

```
  Public Class FtpWebResponse
  Inherits WebResponse
  Public Overrides Property ContentType( ) As String
    Get
      ‘Use the default url
    End Get
    Set(ByVal Value As String)
      ‘Override the default url
    End Set
  End Property
  Public  Overrides  Function  GetResponseStream( )  As
Stream
    ‘Override the default url
  End Function
  End Class
```

This code sets the values of any parameters from the DSP dynamically.

```
Public Class FtpWebRequest
  Inherits WebRequest
  Public Overrides Property Method( ) As String
    Get
      ‘Override
    End Get
    Set(ByVal Value As String)
      ‘Override
    End Set
  End Property
  Public Overrides Property Credentials( ) As
ICredentials
    Get
      ‘Override
    End Get
    Set(ByVal Value As ICredentials)
      ‘Override
    End Set
  End Property
  Public Overrides Property ConnectionGroupName( ) As
String
    Get
      ‘Override
    End Get
    Set(ByVal Value As String)
      ‘Override
    End Set
  End Property
  Public Overrides Property ContentLength( ) As Long
    Get
      ‘Override
    End Get
    Set(ByVal Value As Long)
      ‘Override
    End Set
  End Property
  Public Overrides Property ContentType( ) As String
    Get
      ‘Override
    End Get
    Set(ByVal Value As String)
      ‘Override
    End Set
  End Property
  Public Overrides Property Proxy( ) As IWebProxy
    Get
      ‘Override
    End Get
    Set(ByVal Value As IWebProxy)
      ‘Override
    End Set
  End Property
  Public Overrides Function GetRequestStream( ) As Stream
    ‘Override
  End Function
  Public Overrides Function GetResponse( ) As WebResponse
    ‘Override
  End Function
End Class
```

The DSP selected for an exemplary embodiment was model TMS320C6000 manufactured by Texas Instruments. The other components of the DSP are illustrated in the user/technical manual of the of the manufacturer and, therefore, details are not being provided except naming the components. The DSP includes example programs 220, fast data transfer DirectDSP 225, Win2k Linux drivers 230, TI drivers 235, Hypersignal Macro 240, DSPs 250, 255 and 260, code composer studio 245, DSP/Bios 265, and modules C5xxxSCI and C6xxxSCI appropriately coupled as shown and detailed in the manufacturer's literature.

The DSP stores a database of chemical signatures and corresponding chemicals. Also, the DSP is programmed to receive chemical signature from the IMS and first identify whether the sample is contaminated with a chemical above certain threshold level. Such threshold levels may be set according to the environment in which the apparatus is used, e.g., in the proximity of a chemical plant, or far away in open rural areas and any other parameters deemed significant in the operating environment. Second, if a chemical above certain threshold is detected, the IMS correlates the chemical signature with a chemical in the database and alerts the operator of the results. If no match is found then also the system alerts the operator indicating that an unknown chemical was found but no match could be found.

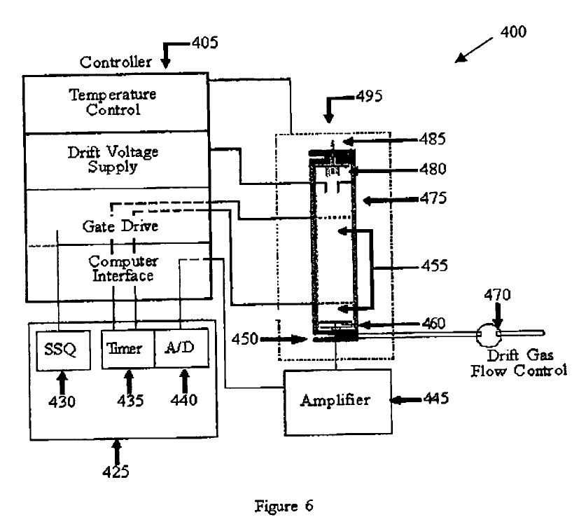

With reference to FIG. 6 is a detailed view 400 of IMS system of the exemplary embodiment of FIG. 2. The heart of the IMS cell is the drift tube 475, which provides a region of constant electric field where ions are created and allowed to migrate. (for construction details see reference 1). The drift tube provides a smooth progression of voltages along the ion path when a supply voltage is connected across the drift tube. A steady flow of ambient-pressure drift gas, usually N2 or air, sweeps through the drift tube and minimizes the buildup of impurities that could otherwise react with ions and distort mobility spectra. Gates 455, fabricated from thin parallel wires, are used to block or pass ions traveling in the drift field. The ion paths terminate at the collector 460, a simple metal screen or plate. Many ion mobility spectrometers contain an aperture grid close to the collector to capacitively decouple the collector from approaching ions.

A number of additional components are needed to provide drift field high voltage, controller 405 for the drift tube temperature and drift gas flow rate, generate timing signals for the gates, isolate gate timing signals from the high voltage of the drift field, amplify the ion signal as it arrives at the collector, and provide signal averaging or other signal processing for the amplifier output.

In an exemplary embodiment, the overall dimensions of the cell are length, 11.2 cm and diameter, 4.5 cm. A resistive coated ceramic field electrode forms the drift region around which is wound a cell heater wire. The reaction region is formed by two metallic rings inserted into the ceramic field electrode with one ring (1.0 cm long by 1.5 cm inside diameter) containing a 15 mCi 63 Ni radioactive source for ionization. A 1.0 cm long reaction ring follows this source ring. Nominal voltages applied across the reactor and drift regions are 0-500 V and 100-1200 V respectively. The planar shutter grid consists of two sets of interdigitally spaced. Parallel wires normal to the axis of the cell. These two sets of wires are biased to normally prevent ions from entering the drift region. A metallic housing functions as a shield against radiofrequency interferences and provides a pathway for the drift gas to flow across the cell heater before entry into the drift region. A membrane inlet prevents direct mixing of external ambient air with the internal purified carrier and drift gases of the cell. Dimethylsilicone (0.0025 cm thick) is used for the membrane. Typical flow rates are 25-175 ml min-l, 50-700 ml min-′ and 0.1-1.0 1 min-′ for the carrier, drift and ambient air sampling gases respectively. The cell is modular in construction to facilitate assembly and modification during testing. (see reference 1).

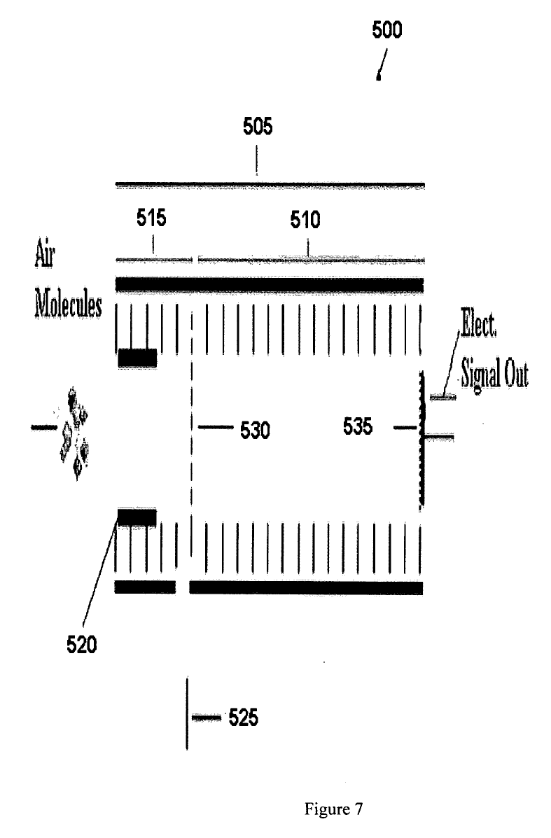

The IMS system operates by taking air molecules that are sucked in by the fan located inside the probe and forces them over a semi-permeable membrane that allows only the materials of interest to enter the detection cell With reference to FIG. 7 is the working principle illustration of an IMS 500 adapted in the exemplary embodiment of FIG. 2. The sample as it is drawn into the reaction region 515 where it is ionized by a radioactive source. The probe has two ion modes; negative and positive. This allows the ion shutter 530 to randomly let either the negative or positive ion affinities enter into the drift region, and unwanted particles will exit through the exhaust. A radioactive source 520 provides the trigger ions. The molecules are moved by the electric field in the drift region 510, which also give polarity to the narcotic and explosive molecules. Narcotic ions usually have a positive ion affinity, while most explosive have a negative ion affinity. Once the needed molecules are in the drift region, the contaminants are identified by the time it takes to travel to the collector, which is proportional to the mass of the molecule and sends a current to the microcontroller. The ions drift towards the collector 535. Next, a microcontroller evaluates the spectrum for the target compound and determines the concentration based on the peak height. The concentration is then displayed on the LCD screen. The analyzed air sample is then expelled through the exhaust 525.

The foregoing disclosure and description of the preferred embodiments are illustrative and explanatory thereof, and various changes in the components, elements, configurations, and signal connections, as well as in the details of the illustrated apparatus and construction and method of operation may be made without departing from the spirit and scope of the invention and within the scope of the claims.

### REFERENCES

1. T. Bacon, J. Reategui, R. Getz, E. Fafaul. “Development of a Gas and Vapor Monitor Based on Ion Mobility Spectrometry,” Paper 90-485, in proceedings of ISA 90 International Conference and Exhibit, New Orleans, La., 1990.

1. A method of detecting an unknown chemical compound, the method comprising:
collecting an air sample from the vicinity of the unknown chemical compound;
analyzing the air sample spectroscopically to determine a chemical signature of the unknown chemical compound; and
associating the chemical signature of the unknown chemical compound with a chemical compound in a database on a Digital Signal Processor (DSP).

2. The method as in claim 1, wherein the collecting the air sample comprises collecting air sample through a probe.

3. The method as in claim 2, wherein the collecting the air sample comprises collecting the air sample from accessible proximity through a tubular probe.

4. The method as in claim 2, wherein the collecting the air sample comprises collecting air sample through a horn shaped probe.

5. The method as in claim 1, wherein the analyzing the air sample comprises analyzing the air sample by Ion Mobility Spectroscopy to determine signature of the unknown chemical compound when present above a certain threshold level.

6. The method as in claim 1, wherein the analyzing the air sample comprises analyzing the air sample by Filter-based Infrared Spectroscopy to determine signature of the unknown chemical compound when present above a certain threshold level.

7. The method as in claim 1, wherein the analyzing the air sample comprises analyzing the air sample by Photo-Acoustic Infrared Spectroscopy to determine signature of the unknown chemical compound when present above a certain threshold level.

8. The method as in claim 1, wherein the analyzing the air sample comprises analyzing the air sample by Photo-Ionization Spectroscopy to determine signature of the unknown chemical compound when present above a certain threshold level.

9. The method as in claim 1, wherein the associating the chemical signature comprises matching the chemical signature with a chemical compound in the database when such association is present.

10. The method as in claim 9, wherein the associating the chemical signature further comprises alerting presence of a new-unknown chemical compound when the chemical signature of the new-unknown chemical compound in the database is absent.

11. The method as in claim 9, wherein the associating the chemical signature further comprises updating the database upon detecting presence of a new-unknown chemical compound.

12. The method as in claim 1, wherein the associating the chemical signature comprises storing a database relating chemical signature and chemical compound on the DSP.

13. The method as in claim 12, wherein the associating the chemical signature further comprises storing a program on the DSP to perform association between the chemical signature and the chemical compounds in the database.

14. The method as in claim 1, wherein the associating the chemical signature further comprises communicating results of the association.

15. The method as in claim 14, wherein the communicating comprises displaying results of the association on a display device.

16. The method as in claim 14, wherein the communicating comprises communicating results of the association with an audio device.

17. The method as in claim 14, wherein the communicating comprises wireless communicating results of the association.

18. An apparatus for detecting an unknown chemical compound, the apparatus comprising:
means for collecting an air sample from the vicinity of the unknown chemical compound;
a spectroscopic analyzer to determine chemical signature of the unknown chemical compound coupled to the means for collecting the air sample; and
a Digital Signal Processor (DSP) coupled to the analyzer, the DSP comprising a database of chemical compounds and their chemical signature and further comprising means for associating the chemical signature with chemical compounds in the database.

19. The apparatus as in claim 18, wherein means for collecting the air sample comprises an air suction device.

20. The apparatus as in claim 18, wherein means for collecting the air sample comprises a suction fan coupled with a tubular pipe.

21. The apparatus as in claim 18, wherein means for collecting an air sample comprises a suction fan coupled with a horn shaped pipe.

22. The apparatus as in claim 18, wherein the analyzer comprises an Ion Mobility Spectroscope.

23. The apparatus as in claim 18, wherein the analyzer comprises a Photo-Acoustic Infrared Spectroscope.

24. The apparatus as in claim 18, wherein the analyzer comprises a Filter-based Infrared Spectroscope.

25. The apparatus as in claim 18, wherein the analyzer comprises a Photo-Ionization Spectroscope.

26. The apparatus as in claim 18, wherein the DSP comprises a Digital Signal Processor capable of storing a database and capable of computer programming.

27. The apparatus as in claim 18, further comprising a position location device.

28. A system of detecting an unknown chemical compound, the system comprising:
means for collecting an air sample from the vicinity of the unknown chemical compound;
means for spectroscopically analyzing the air sample to determine a chemical signature of the unknown chemical compound; and
means for associating the chemical signature of the unknown chemical compound with a chemical compound in a database on a Digital Signal Processor (DSP).

29. The system as in claim 28, wherein the means for collecting the air sample comprises collecting air sample through a probe.

30. The system as in claim 29, wherein the means for collecting the air sample comprises collecting the air sample from accessible proximity through a tubular probe.

31. The system as in claim 29, wherein the means for collecting the air sample comprises collecting air sample through a horn shaped probe.

32. The system as in claim 28, wherein the means for analyzing the air sample comprises an analyzer to determine signature of the unknown chemical compound when present above a certain threshold level.

33. The system as in claim 28, wherein the means for analyzing the air sample comprises an Ion Mobility Spectroscope to determine signature of the unknown chemical compound when present above a certain threshold level.

34. The system as in claim 28, wherein the means for analyzing the air sample comprises a Filter-based Infrared Spectroscope to determine signature of the unknown chemical compound when present above a certain threshold level.

35. The system as in claim 28, wherein the means for analyzing the air sample comprises a Photo-Acoustic Infrared Spectroscope to determine signature of the unknown chemical compound when present above a certain threshold level.

36. The system as in claim 28, wherein the means for analyzing the air sample comprises a Photo-Ionization Spectroscope to determine signature of the unknown chemical compound when present above a certain threshold level.

37. The system as in claim 28, wherein the means for associating the chemical signature comprises matching the chemical signature with a chemical compound in the database when such match is present.

38. The system as in claim 37, wherein the means for associating the chemical signature further comprises alerting presence of a new-unknown chemical compound when the chemical signature of the new-unknown chemical compound in the database is absent.

39. The system as in claim 37, wherein the means for associating the chemical signature further comprises updating the database upon detecting presence of a new-unknown chemical compound.

40. The system as in claim 28, wherein the means for associating the chemical signature comprises storing a database on the DSP.

41. The system as in claim 40, wherein the means for associating the chemical signature further comprises storing a program on the DSP to perform association between the chemical signature and the chemical compounds in the database.

42. The system as in claim 28, wherein the means for associating the chemical signature further comprises communicating results of the association.

43. The system as in claim 42, wherein the means for communicating comprises displaying results of the association on a display device.

44. The system as in claim 43, wherein the means for communicating comprises communicating results of the association with an audio device.

45. The system as in claim 43, wherein the means for communicating comprises communicating results of the association by wireless radio.

46. The system as in claim 43, wherein the means for communicating comprises communicating results of the association by internet.
